(19) United States
(12) Patent Application Publication
(10) Pub. No.: US 2014/0146830 A1
(43) Pub. Date: May 29, 2014

(54) TRANSMISSION CIRCUIT, RECEPTION CIRCUIT, TRANSCEIVER SYSTEM, AND METHOD FOR CONTROLLING THE TRANSCEIVER SYSTEM

(71) Applicant: FUJITSU LIMITED, Kawasaki-shi (JP)

(72) Inventor: Souta KUSACHI, Yokohama (JP)

(73) Assignee: FUJITSU LIMITED, Kawasaki-shi (JP)

(21) Appl. No.: 14/169,716

(22) Filed: Jan. 31, 2014

Related U.S. Application Data
(63) Continuation of application No. PCT/JP2011/067991, filed on Aug. 5, 2011.

(51) Int. Cl. H04L 12/861

(52) U.S. Cl. CPC H04L 49/90
USPC 370/412

(57) ABSTRACT

A transmission circuit includes a buffer that stores a packet transmitted to a reception circuit, a processing unit that reads a retransmission target packet from the buffer, when a retransmission request including processing pattern information that specifies processing to a packet is received from the reception circuit, and that performs the processing specified in the processing pattern information on the retransmission target packet, and an output unit that outputs a processed retransmission target packet to the reception circuit.

### CROSS-REFERENCE TO RELATED APPLICATION

This application is a continuation application of International Application PCT/JP2011/067991 filed on Aug. 5, 2011 and designated the U.S., the entire contents of which are incorporated herein by reference.

### FIELD

The embodiments discussed herein are related to a transmission circuit, a reception circuit, a transceiver system, and a method for controlling the transceiver system.

### BACKGROUND

In transmitting packets between a transmission apparatus and a reception apparatus, when a transmitted packet has a transmission error due to a bit breakage, the transmission apparatus performs a retransmission process in which a packet is retransmitted. When this happens, the retransmitted packet sometimes has a transmission error similarly to the first transmission. In such a case, the transmission apparatus performs an additional retransmission process in which a packet is retransmitted again.

FIG. 1 illustrates a conventional retransmission method.

FIG. 1 illustrates a case in which seven packets from PKT0 to PKT6 are transmitted from a transmission apparatus to a reception apparatus.

When a received packet has an error, the reception apparatus issues a request for retransmitting a substitute for the error packet to the transmission apparatus. At this time, in order to prevent succeeding packets from being processed ahead of the preceding packet, the reception apparatus continues to discard the succeeding packets until the reception of a retransmission packet is completed.

In FIG. 1, because a PKT3 has an error, the reception apparatus requests that the transmission apparatus retransmit the PKT3. The reception apparatus discards received packets PKT3 and those that follow (PKT3 to PKT6). The transmission apparatus, which has received a retransmission request, retransmits the PKT3 and after.

When a retransmitted packet has an error, the reception apparatus issues a retransmission request again to the transmission apparatus, and the transmission apparatus re-retransmits a packet.

In FIG. 1, because a retransmitted PKT3 also has an error, the reception apparatus requests the transmission apparatus to retransmit the PKT3 again. The reception apparatus discards the retransmitted PKT3 and all packets received later than the retransmitted PKT3 (PKT3 to PKT6). The transmission apparatus re-retransmits the PKT3 and those that follow. There are no errors in re-retransmitted PKT3 to PKT6, and therefore, the reception apparatus completes the reception of packets.

In an apparatus used with a transfer speed enhanced as much as possible, the transmission/reception conditions are severe, and therefore, a situation in which transmitted packets also have an error is likely to occur.

In the conventional retransmission method, the retransmission of packets is repeated up to a point at which a retransmitted packet has an error, and the succeeding packets continue to be discarded. Therefore, the conventional retransmission method has a problem wherein a transmission rate becomes unstable.

### [Patent Document 1] Japanese Laid-open Patent Publication No. 2003-8553

### [Patent Document 2] Japanese Laid-open Patent Publication No. 10-247901

### [Patent Document 3] Japanese Laid-open Patent Publication No. 2000-216812

### SUMMARY

According to an aspect of the invention, a transmission circuit includes a buffer, a processing unit, and an output unit.

The buffer stores packets transmitted to a reception circuit.

When the processing unit receives a retransmission request including processing pattern information that specifies processing to a packet, from the reception circuit, the processing unit reads a retransmission target packet from the buffer, and performs the processing specified in the processing pattern information on the retransmission target packet.

The output unit outputs a processed retransmission target packet to the reception circuit.

According to an aspect of the invention, a reception circuit includes a buffer, retransmission request means, a restoration unit, and a complementing unit.

The buffer stores an initial packet received first from a transmission circuit.

The retransmission request means requests that the transmission circuit retransmit a packet.

The restoration unit restores a retransmission packet processed in the transmission circuit to a state before the processing.

The complementing unit combines the initial packet with a restored retransmission packet so as to configure a packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a conventional retransmission method.

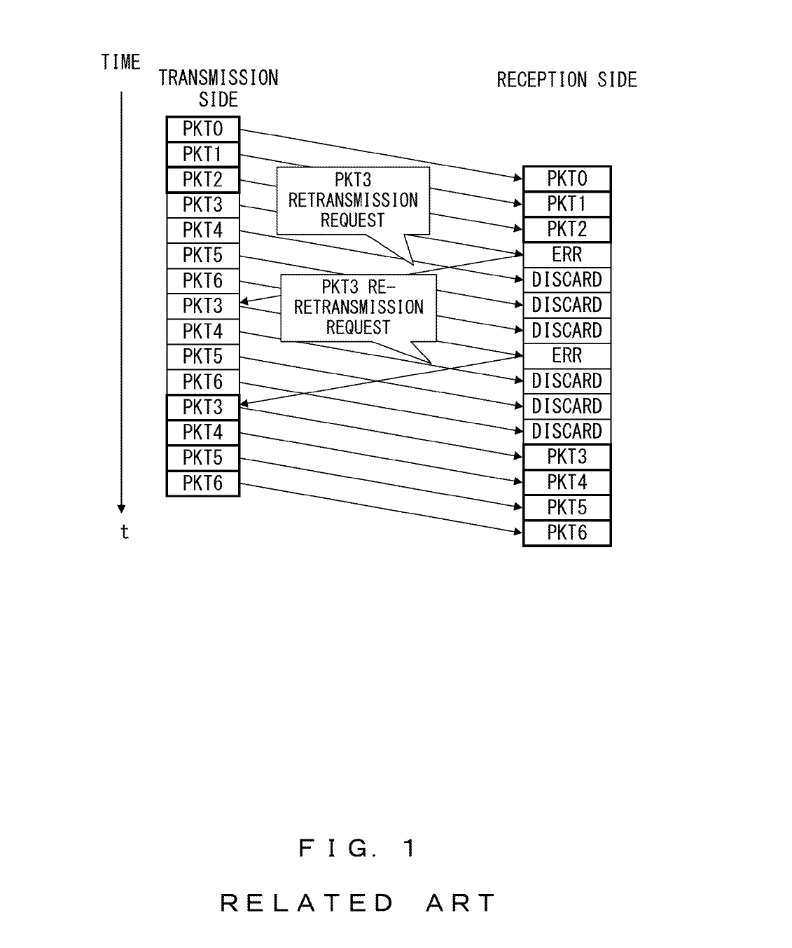

FIG. 2 illustrates a configuration of a system according to an embodiment.

FIG. 3 illustrates a retransmission method according to an embodiment.

FIG. 4 illustrates a configuration of a transmission circuit according to an embodiment.

FIG. 5 illustrates a configuration of a packet according to an embodiment.

FIG. 6 illustrates data of packets before and after a data value inversion process.

FIG. 7A illustrates packets before and after a rearrangement process (pattern A).

FIG. 7B illustrates packets before and after a rearrangement process (pattern B).

FIG. 8A illustrates an error packet.

FIG. 8B illustrates another error packet.

FIG. 9 illustrates packets before and after a same data continuous arrangement process.

FIG. 10 illustrates another error packet.

FIG. 11 illustrates a configuration of a reception circuit according to an embodiment.

FIG. 12 illustrates a configuration of an error check circuit according to an embodiment.

FIG. 13 illustrates a configuration of a restoration circuit according to an embodiment.

FIG. 14 illustrates a configuration of a complementing circuit according to an embodiment.

FIG. 15 illustrates a complementing process according to an embodiment.

FIG. 16 is a flowchart of processes of a transmission circuit and a reception circuit according to an embodiment.

### DESCRIPTION OF EMBODIMENTS

Embodiments are described below with reference to the drawings.

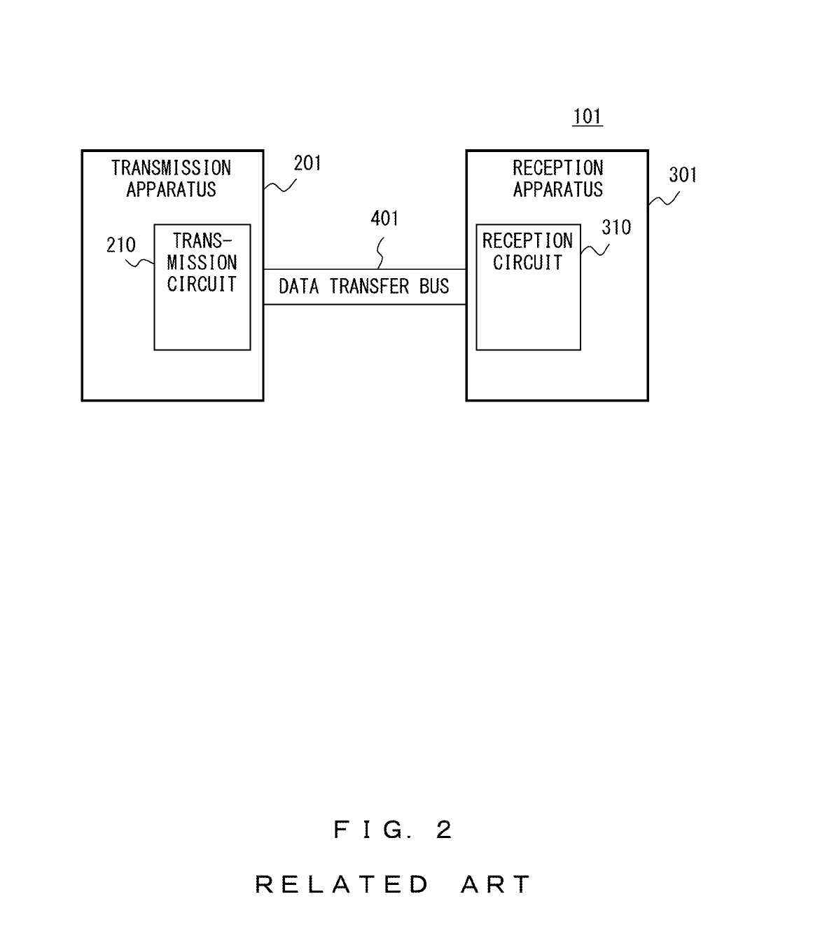

FIG. 2 illustrates a configuration of a system according an embodiment.

A system 101 includes a transmission apparatus 201 and a reception apparatus 301.

The transmission apparatus 201 and the reception apparatus 301 are connected through a data transfer bus 401. The data transfer bus 401 is, for example, a serial bus, etc.

The transmission apparatus 201 includes a transmission circuit 210.

The transmission circuit 210 transmits a packet to the reception apparatus 301. When the transmission circuit 210 receives a packet retransmission request from the reception apparatus 301, the transmission circuit 210 processes the packet and transmits the processed packet to the reception apparatus 301.

The reception apparatus 301 includes a reception circuit 310.

The reception circuit 310 receives a packet from the transmission apparatus 201. When the received packet has an error, the reception circuit 310 issues a retransmission request to the transmission apparatus 201. The reception circuit restores the processed packet to a state before the processing.

The reception circuit 310 performs a complementing process in which a packet received initially (an initial packet) and a packet received for the second time or later (a retransmission packet) are combined so as to configure a normal packet.

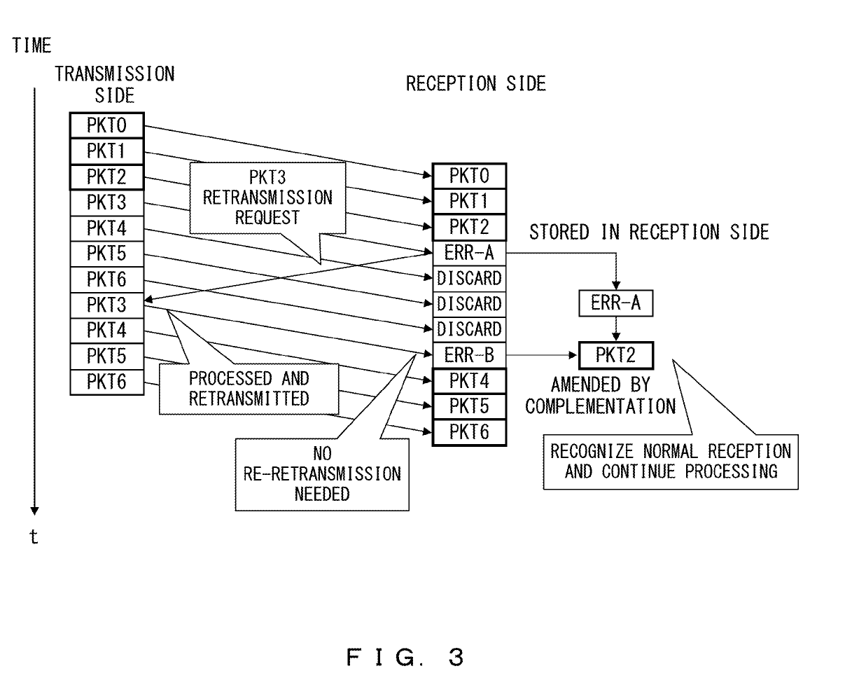

FIG. 3 illustrates a retransmission method according to an embodiment.

FIG. 3 illustrates a case in which seven packets from PKT0 to PKT6 are transmitted from the transmission apparatus 201 to the reception apparatus 301.

In FIG. 3, because a PKT 3 has an error, the reception apparatus requests that the transmission apparatus retransmit the PKT3. The reception apparatus stores the PKT3 with an error in a buffer, and discards packets received later than the PKT3 (PKT4 to PKT6). The transmission apparatus, which received a retransmission request, processes the PKT3, and retransmits the processed PKT3. Further, the transmission apparatus retransmits packets following the PKT3 (PKT4 to PKT 6).

In FIG. 3, assume that the retransmitted PKT3 also has an error. Also assume that an error portion in the retransmitted PKT3 is different from an error portion in the PKT3 received initially. The reception apparatus restores the processed PKT3, and combines the initial received PKT3 with the restored PKT3 so as to configure a normal PKT3. The reception apparatus recognizes that the PKT3 has been received normally, and continues the processing, and it receives a PKT4, a PKT5, and a PKT6.

As described above, in this embodiment, even when a retransmission packet has an error, an initial packet and the retransmission packet are combined so as to configure a normal packet, and as a result, a re-retransmission is not needed.

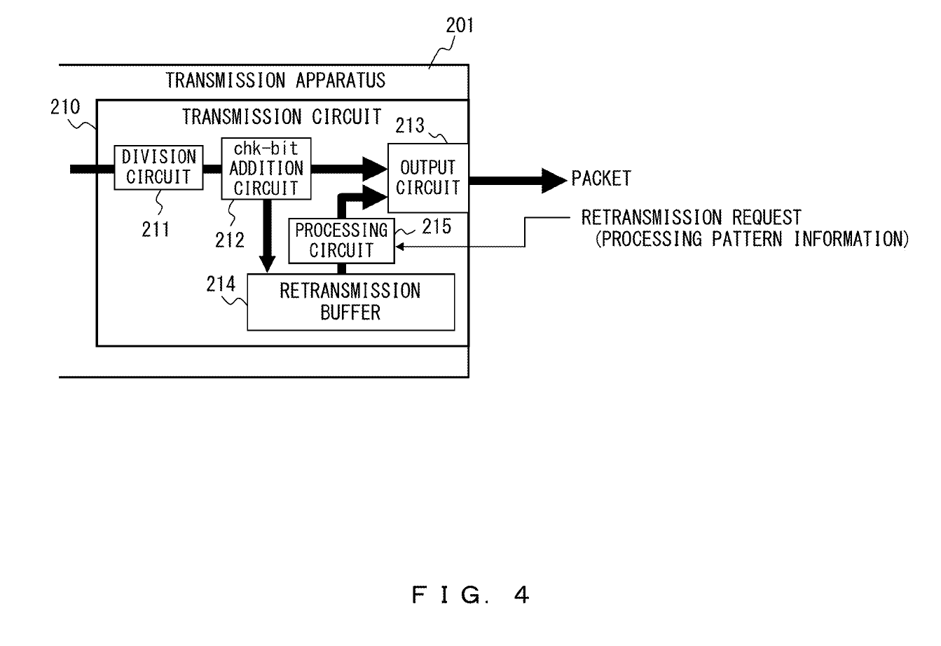

FIG. 4 illustrates a configuration of a transmission circuit according to an embodiment.

The transmission circuit 210 includes a division circuit 211, a check bit (chk-bit) addition circuit 212, an output circuit 213, a retransmission buffer 214, and a processing circuit 215.

The division circuit 211 divides data input from another processor (not illustrated) in the transmission apparatus 201 into a plurality of blocks, and outputs them to the chk-bit addition circuit 212. In this embodiment, the division circuit 211 divides data into ten blocks. Further, the blocks are expressed as a block 0 to a block 9, respectively.

The chk-bit addition circuit 212 adds a check bit used for an error check to each of the blocks. For the check bit, a Cyclic Redundancy Check (CRC), a parity, an Error Correcting Code (ECC), or the like is used, for example.

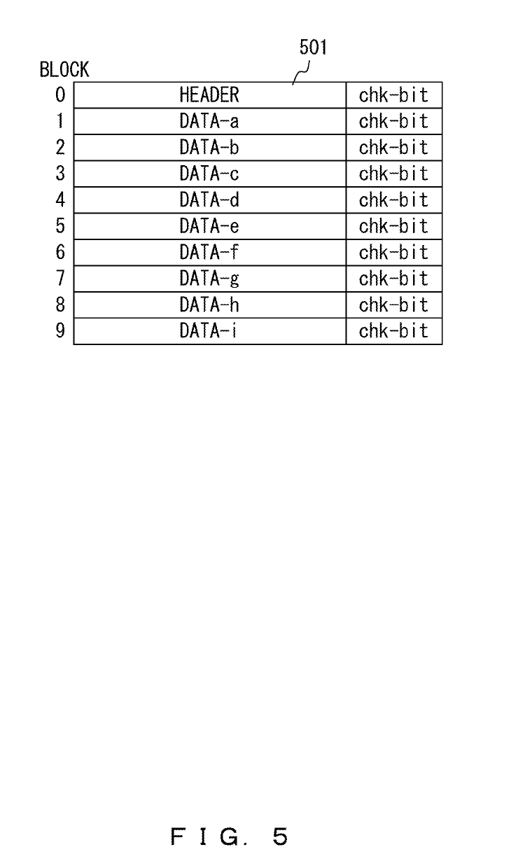

The division circuit 211 and the chk-bit addition circuit 212 configure a packet initially transmitted to the reception circuit 301. A packet 501 in this embodiment has a form as illustrated in FIG. 5.

In the packet 501 illustrated in FIG. 5, a header is stored in a block 0, and DATA-a to DATA-i are stored as a data body (a payload) respectively in blocks 1 to 9. The header is information other than the data body, such as the type of a packet, a transmission destination address, or a transmission source address. Further, a check bit is added to each of the blocks.

The chk-bit addition circuit 212 outputs the packet 501 to the output circuit 213 and the retransmission buffer 214.

The output circuit 213 outputs a packet input from the chk-bit addition circuit 212 or the processing circuit 215, to the reception apparatus 301. A packet input from the chk-bit addition circuit 212 is an initial packet, and a packet input from the processing circuit 215 is a retransmission packet.

The retransmission buffer 214 stores the packet 501 input from the chk-bit addition circuit 212.

The processing circuit 215 receives a retransmission request including processing pattern information from the reception apparatus 301, and reads the packet 501 from the retransmission buffer 214. Then, the processing circuit 215 performs the processing specified in the processing pattern information on the packet 501, and outputs the processed packet to the output circuit 213.

The transmission circuit 201 according to this embodiment transmits the packet processed in the processing circuit 215 as a retransmission packet at the time of retransmitting the packet.

Described next is the processing performed in the processing circuit 215 at the time of retransmitting a packet.

According to an embodiment, the processing to a packet is at least one of (1) a data value inversion process, (2) a block rearrangement process, and (3) a same data continuous arrangement process. The processing circuit 215 performs the processing which is specified in the processing pattern information included in the retransmission request.

The above three processes are described below.

(1) Data Value Inversion Process

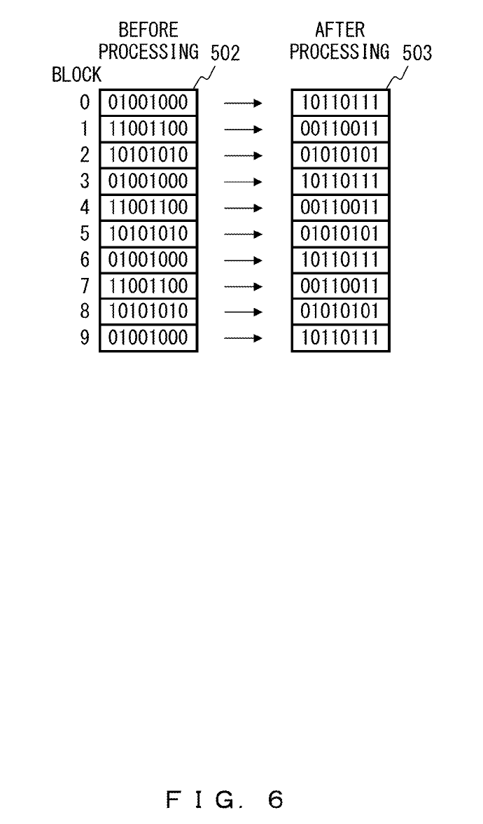

FIG. 6 illustrates data of packets before and after a data value inversion process.

A packet 502 expresses packet data before the data value inversion process, and a packet 503 expresses packet data after the data value inversion process.

When the data value inversion process is performed, the processing circuit 215 inverts all “0”s and “1”s in packet data. Namely, the processing circuit 215 inverts all pieces of data “0” in the packet to “1”, and inverts all pieces of data “1” to “0”. As a result of this inversion process, as illustrated in FIG. 6, the data of a packet after the data value inversion process, i.e., the packet 503, is inverted in “0” and “1” relative to the packet 502.

In a case in which a transmission error which tends to occur in a specified data pattern due to the physical characteristics of an apparatus, etc., occurred in an initial transmission, when exactly the same data is transmitted at the time of retransmission, it is likely that a phenomenon similar to that in the initial transmission will occur and that a transmission error will occur again. In view of this, by inverting all of the “0”s and “1”s in the data of the initial transmission at the time of retransmission, as illustrated in FIG. 6, the likelihood of avoiding a pattern in which a transmission error tends to occur can be increased.

In FIG. 6, the data value inversion process is performed on all of the blocks. However, the data value inversion process may be performed on, for example, every other block, i.e., every odd-numbered or even-numbered block. Further, the data value inversion process may be performed on a specified bit in each of the blocks so that, as an example, an n-th bit in each of the blocks is always “1”.

As described above, a transmission error can be suppressed by switching the setting of an inversion pattern in accordance with the characteristics of an apparatus and operating the apparatus.

(2) Block Rearrangement Process

As the next example, a block rearrangement process is described below.

In an apparatus with a characteristic whereby a transmission error tends to occur when a specified data pattern continues, the occurrence of a transmission error at the time of retransmission can be suppressed by rearranging blocks.

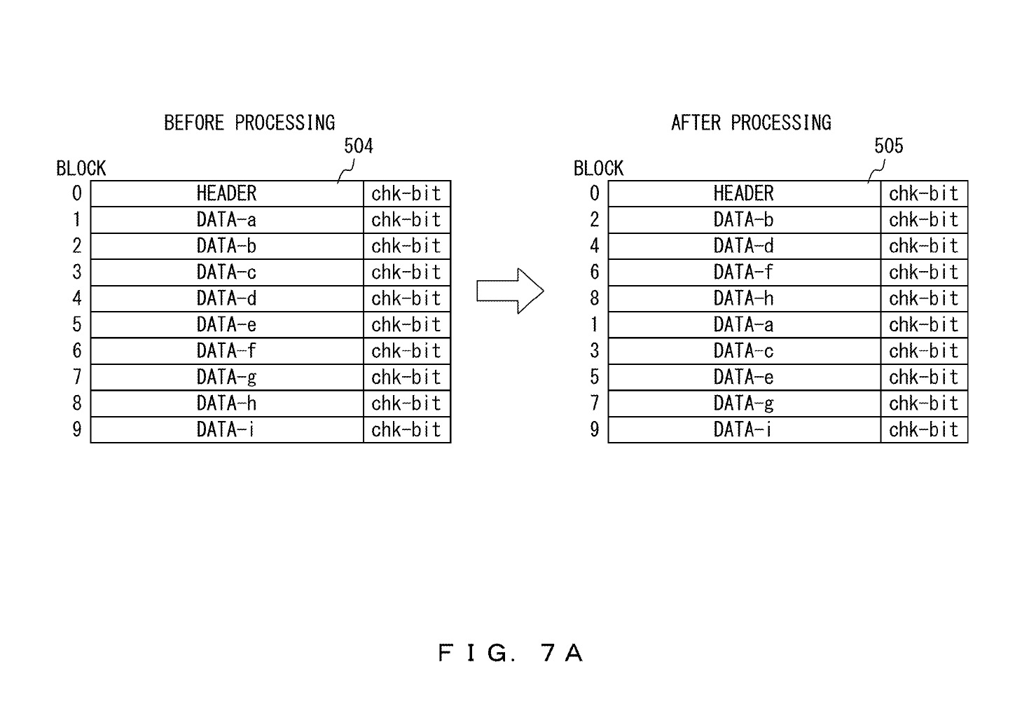

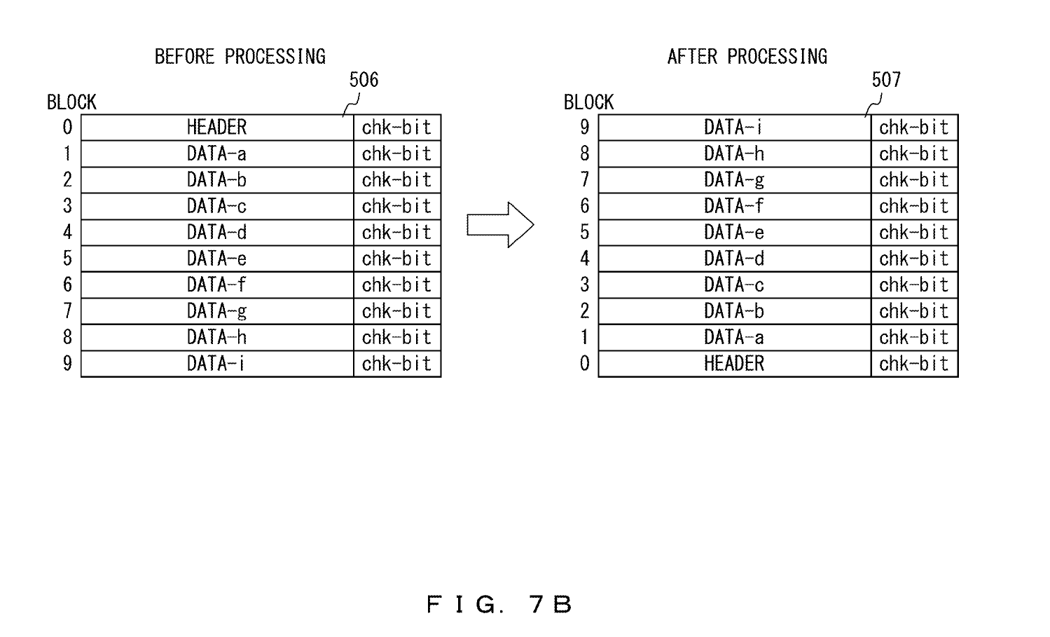

FIGS. 7A and 7B illustrate two examples of a rearrangement pattern according to an embodiment. The rearrangement patterns are expressed as (i) a rearrangement process based on odd/even numbers (pattern A) and (ii) a rearrangement process from in ascending order to in descending order (pattern B), respectively.

(i) Rearrangement Process Based on Odd/Even Numbers (Pattern A)

FIG. 7A illustrates packets before and after a rearrangement process (pattern A).

A packet 504 is a packet before the rearrangement process, and a packet 505 is a packet after the rearrangement process.

In the rearrangement process based on odd/even numbers, the processing circuit 215 gathers even-numbered blocks in the packet 504 before the process in the first half of the packet. Namely, the even-numbered blocks are arranged in order from the top of the packet. Further, the processing circuit 215 gathers odd-numbered blocks in the second half of the packet. Namely, the odd-numbered blocks are arranged after the gathered even-numbered blocks.

As a result, as illustrated in FIG. 7A, in the packet 505 after the rearrangement process, the even-numbered blocks are arranged in order from the top and the odd-numbered blocks are arranged after the even-numbered blocks.

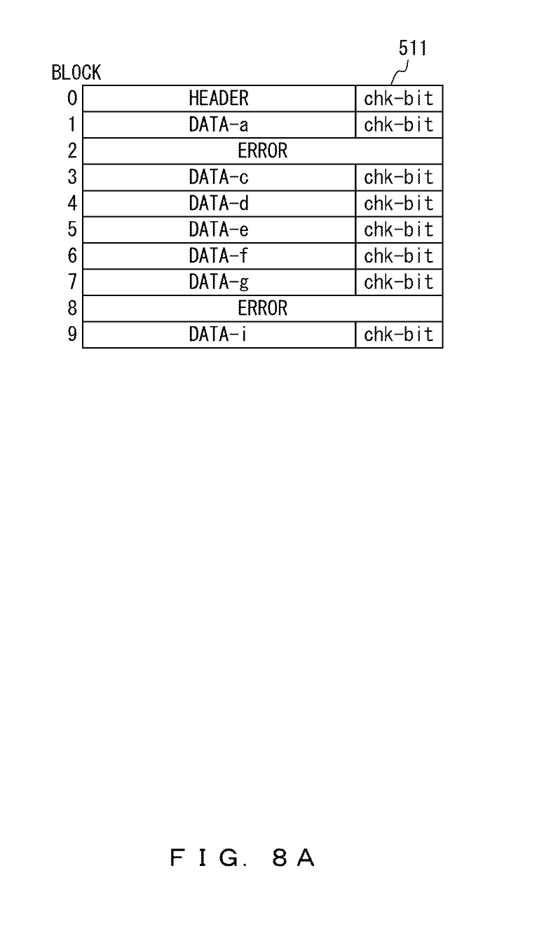

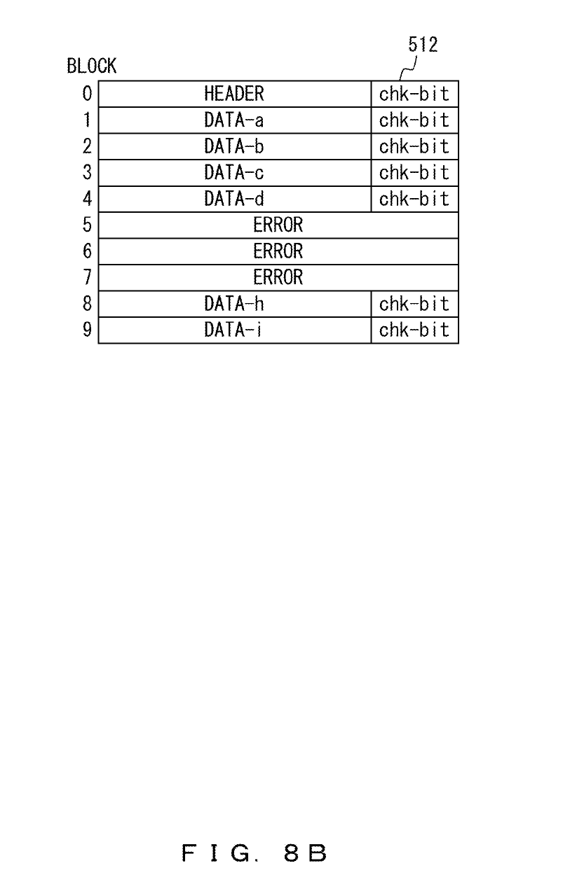

As an example, as illustrated in FIG. 8A, when errors discretely occur in a received packet 511, it is considered that the arrangement of blocks before and after the error blocks has caused the errors. Therefore, it is preferable to apply the pattern A in order to change the blocks before and after the error blocks.

(ii) Rearrangement Process From in Ascending Order to in Descending Order (Pattern B)

FIG. 7B illustrates packets before and after a rearrangement process (pattern B).

A packet 506 is a packet before the rearrangement process, and a packet 507 is a packet after the rearrangement process.

In the rearrangement process from in ascending order to in descending order, the processing circuit 215 reverses the order of blocks in the packet 506 before the process.

As a result, as illustrated in FIG. 7B, blocks in the packet 506 before the rearrangement process are arranged in ascending order, whereas blocks in the packet 507 after the rearrangement process are arranged in the reverse order, i.e., in descending order from a block 9.

As an example, as illustrated in FIG. 8B, when errors occur in a plurality of consecutive blocks in a received packet 512, it is considered that the arrangement order of the plurality of blocks has caused the errors. Therefore, it is preferable to apply the pattern B in which the order of all blocks is reversed.

In an apparatus in which an error tends to occur in a specified block in transmitted data from the start of a packet transmission or an apparatus in which errors occur depending on the arrangement order of data, transmission errors are effectively avoided by the rearrangement of blocks as described above.

(3) Same Data Continuous Arrangement Process

As the next example, a same data continuous arrangement process is described below.

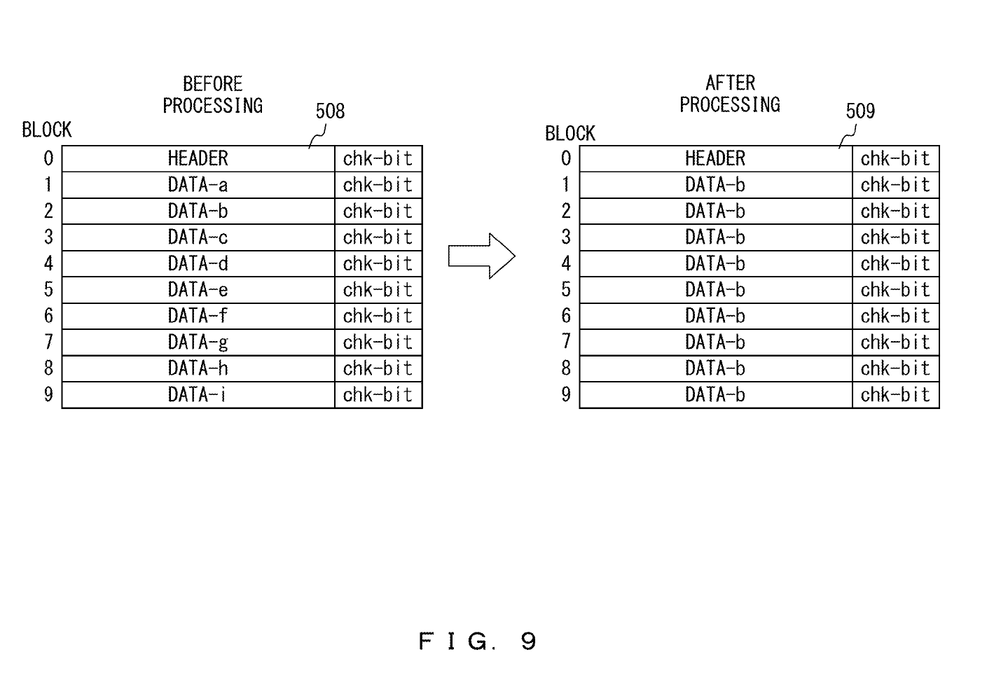

FIG. 9 illustrates packets before and after the same data continuous arrangement process.

A packet 508 is a packet before the process, and a packet 509 is a packet after the same data continuous arrangement process.

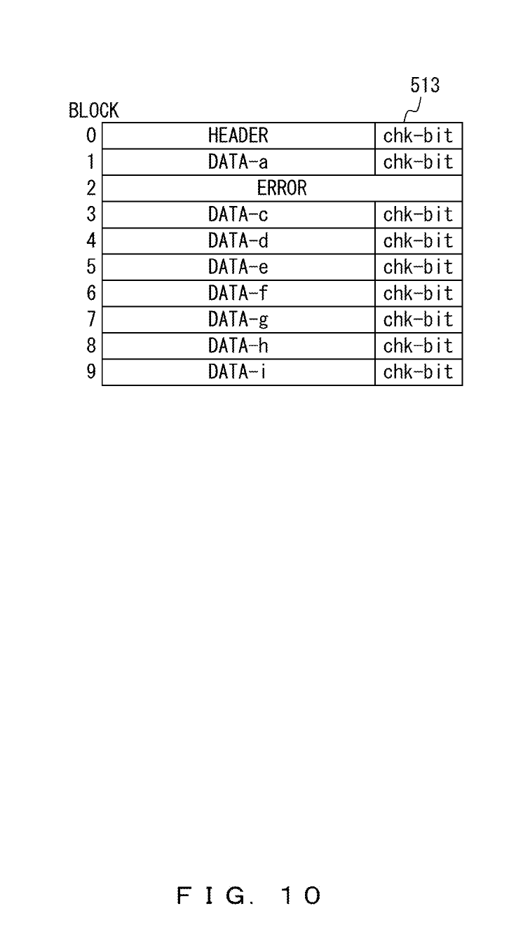

As an example, as illustrated in FIG. 10, when an error occurs in a block 2 in a received packet 513, it is considered that the same data continuous arrangement process in which plural pieces of data, i.e., a header and data in a block 2, are transmitted should be performed.

When the same data continuous arrangement process is performed, a retransmission request includes error block information indicating an error block.

In the same data continuous arrangement process, the processing circuit 215 replaces data in blocks other than a block 0 from among a plurality of blocks included in a packet before the process with a specified block.

In this example, a block 2 is specified in the error block information.

In the same data continuous arrangement process, as illustrated in FIG. 9, respective pieces of data in a block 1 to a block 9 in the packet 509 after the same data continuous arrangement process are DATA-b, which is data in a block 2 in which an error occurred in an initial packet.

In blocks which were specified as described above, there were no transmission errors at the time of initial transmission, and normal data arrived at the reception apparatus. Therefore, there is no need for retransmission. The success rate of the retransmission can increase by allocating data in a block to which data needs to be retransmitted to a block to which data does not need to be retransmitted.

In an apparatus in which transmission errors randomly occur without depending on a data pattern or a timing or an apparatus in which a principle of the occurrence of errors cannot be found out, the processing as described above is effective.

In the transmission circuit according to the embodiment, the likelihood of the occurrence of errors in a retransmission packet can be reduced by processing the packet at the time of retransmission.

Accordingly, the likelihood of the repeated occurrences of a retransmission can be reduced and a transmission rate can be stabilized.

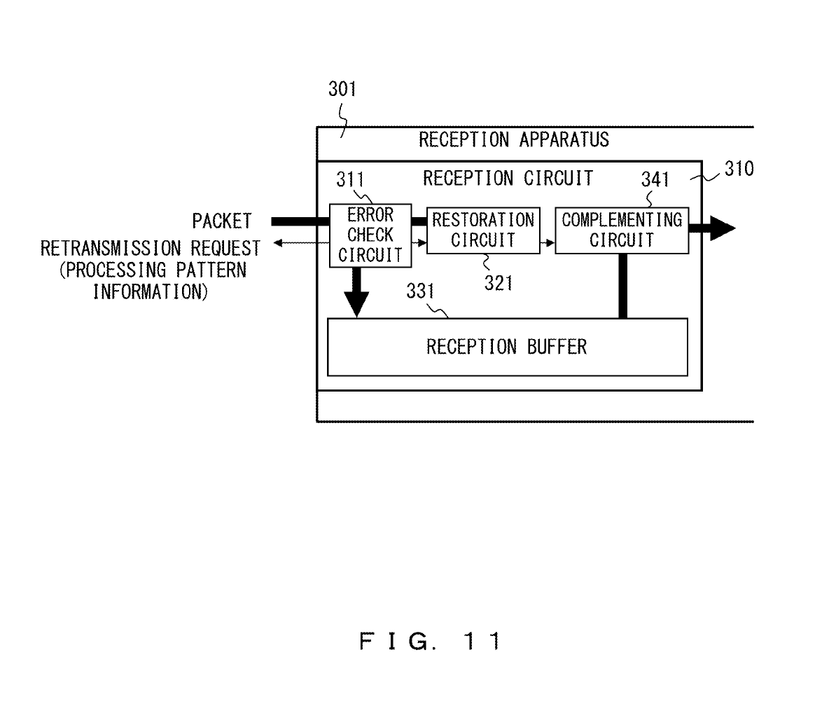

FIG. 11 illustrates a configuration of a reception circuit according to an embodiment.

A reception circuit 310 includes an error check circuit 311, a restoration circuit 321, a reception buffer 331, and a complementing circuit 341.

The error check circuit 311 determines whether there is an error in a received packet. If there is an error, the error check circuit 311 issues a retransmission request including processing pattern information to the transmission circuit 201. Further, the error check circuit 311 outputs the received packet to the restoration circuit 321 and the reception buffer 331.

The restoration circuit 321 restores a packet processed in the transmission circuit 310 to a state before the processing.

The reception buffer 331 stores a packet initially received (an initial packet).

The complementing circuit 341 reads the initial packet from the reception buffer, and combines the initial packet with the packet restored in the restoration circuit 321 so as to configure a packet without any errors. The complementing circuit outputs a normal packet to another processor (not illustrated) in the reception apparatus 301.

If there are no errors in the initial packet, the restoration circuit 321 and the complementing circuit 341 pass the initial packet.

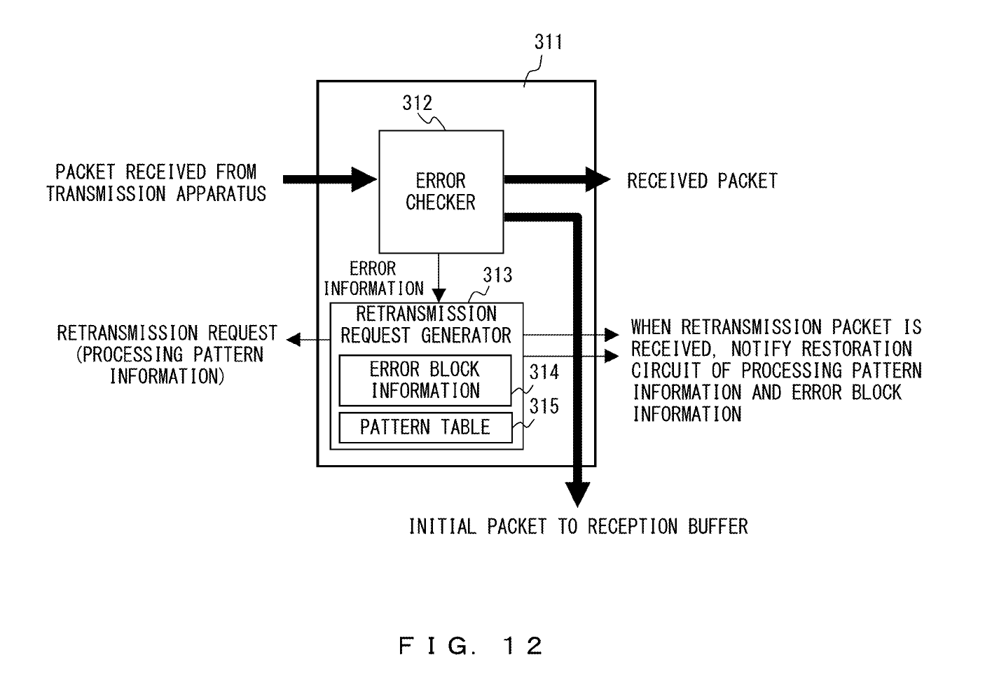

FIG. 12 illustrates a configuration of an error check circuit according to an embodiment.

The error check circuit 311 includes an error checker 312 and a retransmission request generator 313.

The error checker 312 determines whether there is an error in a received packet using a check bit added to each of the blocks in the received packet.

When the received packet is a retransmission packet, the error checker 312 determines whether it can be complemented. If it can be complemented, the error checker 312 outputs the received packet to the restoration circuit 321. The error checker 312 refers to error block information 314. If an error block in the initial packet is different from an error block in the retransmission packet, the error checker 312 determines that it can be complemented.

The error checker 312 outputs the initial packet to the reception buffer 331.

The error checker 312 outputs error information to the retransmission request generator 313. The error information includes information such as the number of retransmission times, the number of an error block, or the arrangement of the error block (consecutive or single).

The retransmission request generator 313 includes the error block information 314 and a pattern table 315.

The error block information 314 is information indicating the number of a block with an error, which is included in a received packet. In the error block information 314, the number of the error block included in the error information is given.

The retransmission request generator 313 holds the error block information 314 until the decision that a packet can be complemented.

The pattern table 315 is used when the retransmission request generator 313 selects processing pattern information from the error information.

In the pattern table 315, the processing pattern information selected by the retransmission request generator 313 is described that corresponds to conditions such as the arrangement of an error block “consecutive blocks/single block”, or the number of retransmission times “twice or less/three times or more”, which is included in the error information.

In the pattern table 315, the following information is for example described:
Retransmission times: twice or less; single block=“same data continuous arrangement process”
Retransmission times: twice or less; consecutive blocks=“data value inversion process”
Retransmission times: three times or more; single block=“data value inversion process”
Retransmission times: three times or more; consecutive blocks=“block rearrangement process (pattern B)”

The retransmission request generator 313 specifies the processing, such as a data value inversion process, a block rearrangement process, or a same data continuous arrangement process, as the processing pattern information, based on the error information.

As an example, when the error information indicates “Retransmission times: twice or less; single block”, the retransmission request generator 313 specifies “same data continuous arrangement process” as the processing pattern information.

The retransmission request generator 313 transmits a request for retransmitting a substitute for a packet with an error, including the processing pattern information, to the transmission apparatus 201. Further, the retransmission request generator 313 includes the error block information 314 in the retransmission request when it specifies the same data continuous arrangement process as the processing pattern information.

The retransmission request generator 313 notifies the restoration circuit 321 of the processing pattern information and the error block information 314 at the time of receiving a retransmission packet.

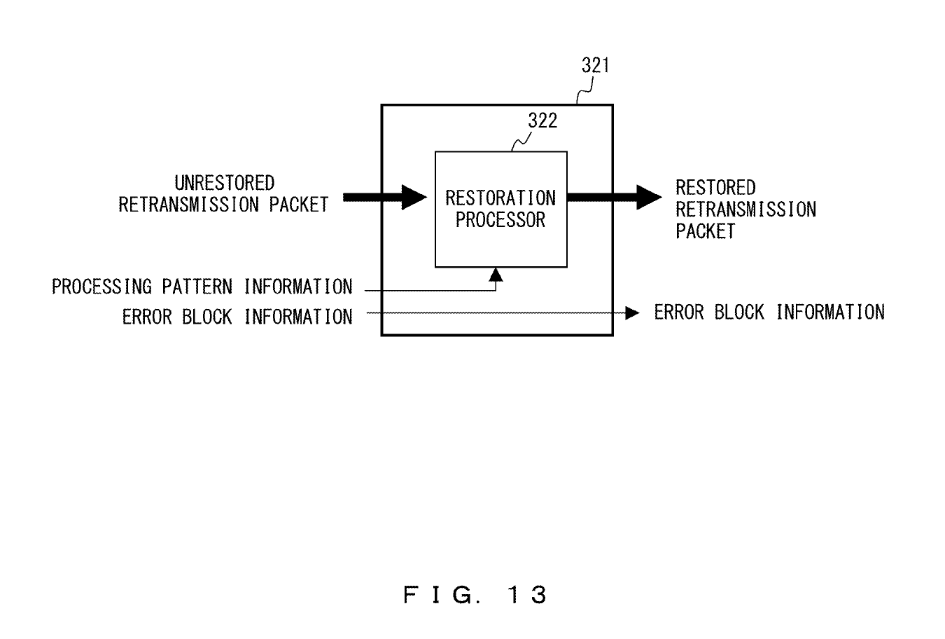

FIG. 13 illustrates a configuration of a restoration circuit according to an embodiment.

The restoration circuit 321 includes a restoration processor 322.

The restoration circuit 321 outputs the input error block information 314 to the complementing circuit 341.

The restoration processor 322 restores the input and unrestored packet to a state before the processing. The restoration processor 322 performs a restoration process on the unrestored packet based on the processing pattern information.

As an example, when the processing pattern information indicates the data value inversion process, the data value inversion process is performed on the unrestored packet. As another example, when the processing pattern information indicates the block rearrangement process, blocks in the unrestored packet are rearranged so as to be in a state before the rearrangement process.

The restoration processor 322 outputs the restored packet to the complementing circuit 341.

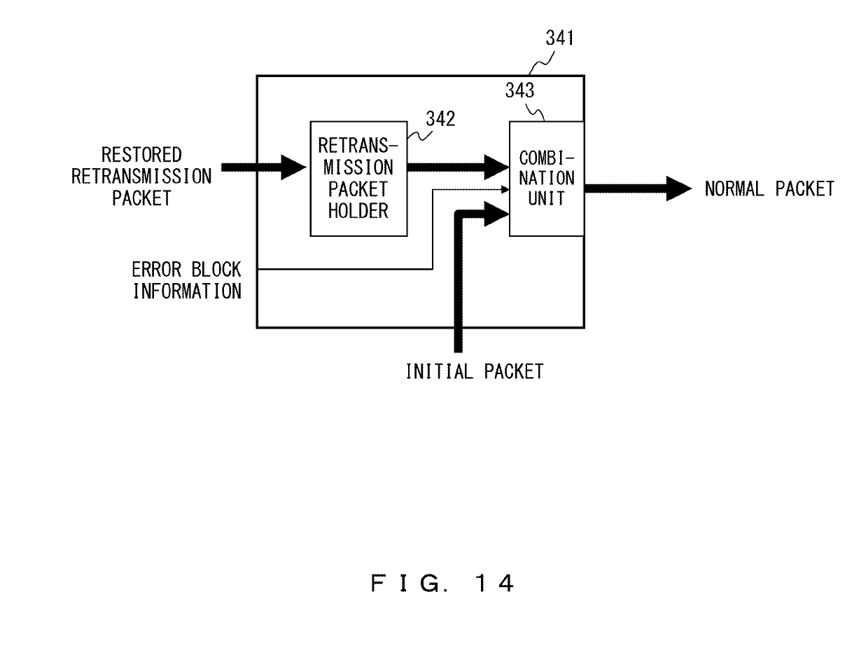

FIG. 14 illustrates a configuration of a complementing circuit according to an embodiment.

The complementing circuit 341 includes a retransmission packet holder 342 and a combination unit 343.

The retransmission packet holder 342 holds a restored retransmission packet.

The error block information is input to the combination unit 343.

The combination unit 343 reads the initial packet from the reception buffer 331, reads the restored retransmission packet from the retransmission packet holder 342, and configures a packet without any errors (a normal packet) from the initial packet and the restored retransmission packet using the error block information. Specifically, a block in the initial packet indicated in the error block information is replaced with a block in the restored retransmission packet indicated in the error block information so as to configure a normal packet. A process of configuring a normal packet is referred to as a complementing process.

The combination unit 343 outputs the normal packet to another processor in the reception apparatus 301.

Next an example of the complementing process is described.

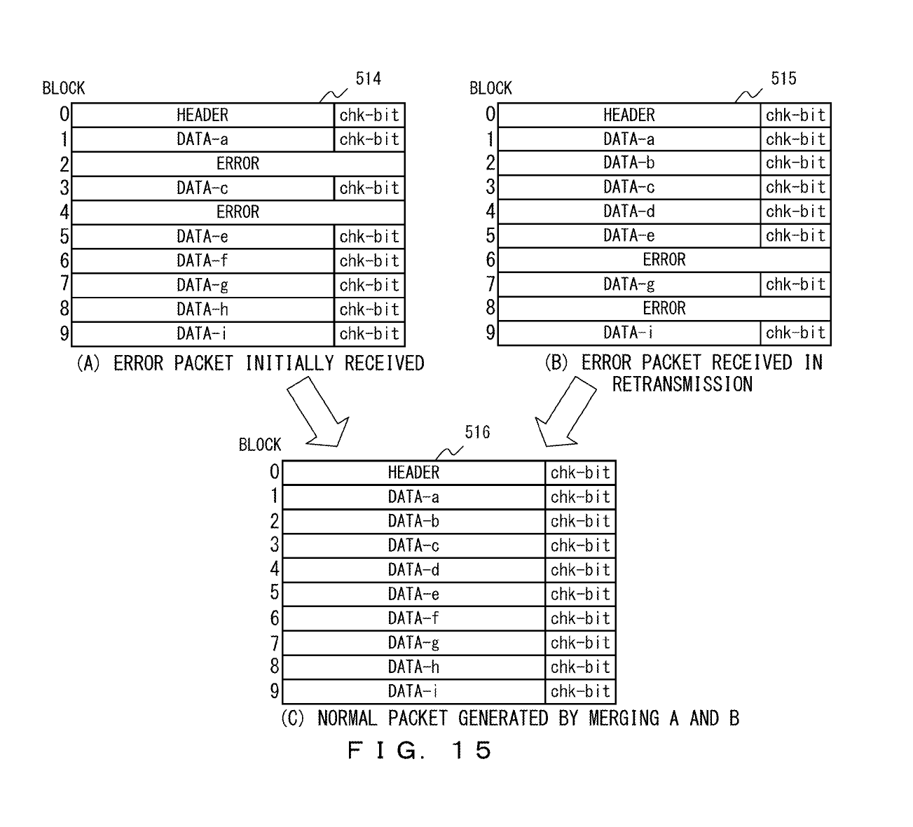

FIG. 15 illustrates a complementing process according to an embodiment.

The complementing process is performed in the complementing circuit 341 as illustrated in FIG. 14 described above.

FIG. 15 illustrates an example in which an initial packet 514 and a retransmission packet 515 are combined so as to configure a normal packet 516.

The initial packet 514 has errors in a block 2 and a block 4.

A restored retransmission packet 515 has errors in a block 6 and a block 8.

Further, error block information input to the combination unit 343 indicates that error blocks in an initial packet, i.e., a block 2 and a block 4, are error blocks.

The combination unit 343 replaces the block 2 and the block 4 in the initial packet 514 with a block 2 and a block 4 in the restored retransmission packet 515, respectively, based on the error block information so as to configure the normal packet 516.

As described above, the combination unit 343 combines an initial packet with a restored retransmission packet so as to configure a normal packet.

In the reception circuit according to the embodiment, a normal packet can be configured by combining an initial packet and a retransmission packet, even when each of the packets has an error. Namely, even when the retransmission packet has an error block but the position of the error block in the retransmission packet is different from the position of the error block in the initial packet, a normal packet can be configured. As a result, a likelihood of the repeated occurrence of a retransmission can be reduced. Accordingly, a transmission rate is stabilized.

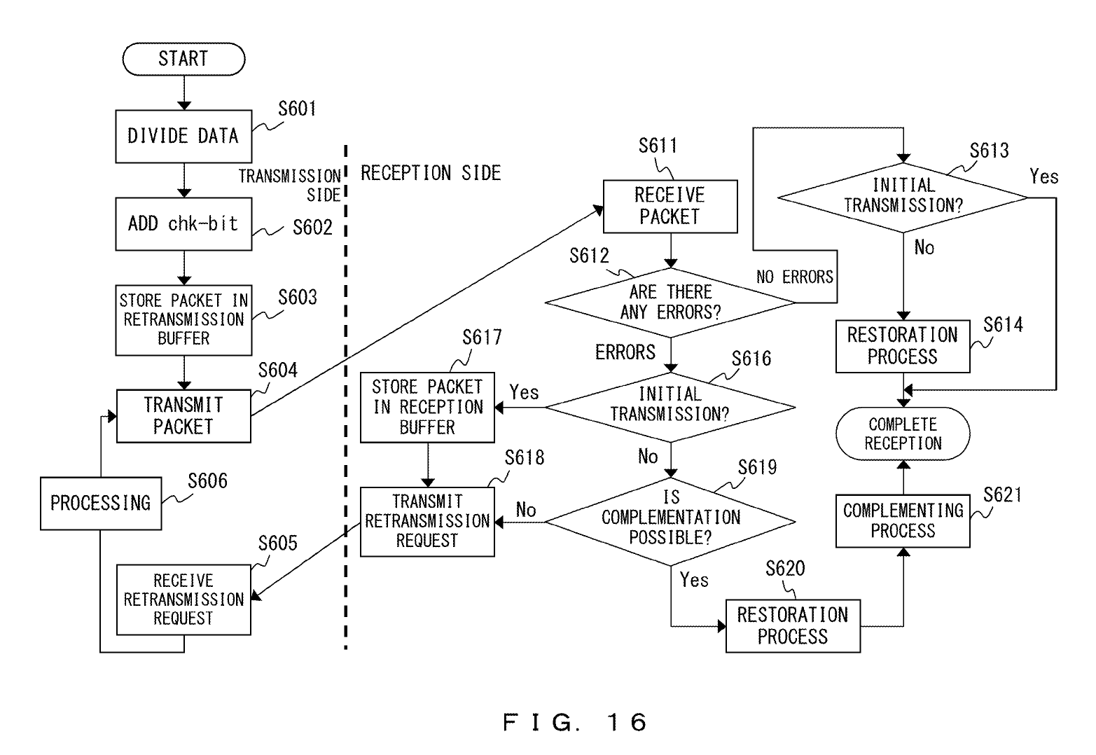

FIG. 16 is a flowchart of processes of a transmission circuit and a reception circuit according to an embodiment.

The left side of FIG. 16 (steps S601-S606) illustrates a process of the transmission circuit 210, and the right side (steps S611-S621) illustrates a process of the reception circuit 310.

First, the process of the transmission circuit 210 is described.

In step S601, the division circuit 211 divides a piece of input data into a plurality of blocks.

In step S602, the chk-bit addition unit 212 adds a check bit used for an error check to each of the blocks.

In step S603, the retransmission buffer 214 stores a packet that is initially transmitted.

In step S604, the output circuit 213 outputs a packet input from the chk-bit addition unit 212 to the reception circuit 310.

In step S605, the processing circuit 215 receives a retransmission request including processing pattern information. The retransmission request sometimes includes the error block information 314.

In step S606, the processing circuit 215 reads a packet from the retransmission buffer 214, performs the processing specified in the processing pattern information on the packet, and outputs the processed packet to the output circuit 213.

When the processing circuit 215 performs the processing, in step S604, the output circuit 213 outputs a packet input from the processing circuit 215 to the reception circuit 310.

Next, the process of the reception circuit 310 is described.

In step S611, the error checker 312 receives a packet from the transmission circuit 210. The received packet is an initial packet or a retransmission packet.

In step S612, the error checker 312 determines for each block whether there is an error in the received packet using a check bit. When there is an error in the received packet, the control proceeds to step S616. When there are no errors, the control proceeds to step S613.

In step S613, the error checker 312 determines whether the transmission of the received packet is an initial transmission. If it is an initial transmission, the process is finished. If it is not an initial transmission, the control proceeds to step S614.

In step S614, the restoration circuit 321 refers to the processing pattern information for the received packet (a retransmission packet), and performs a restoration process according to the processing pattern information.

In step S616, the error checker 312 determines whether the transmission of the received packet is an initial transmission. If it is an initial transmission, the control proceeds to step S617. If it is not an initial transmission, the control proceeds to step S619.

In step S617, the received packet (an initial packet) is stored in the reception buffer 331.

In step S618, the retransmission request generator 313 outputs a retransmission request including the processing pattern information to the transmission apparatus 201.

In step S619, the error checker 312 determines whether the initial packet can be complemented with the received packet (a retransmission packet). If it can be complemented, the control proceeds to step S620. If it cannot be complemented, the control proceeds to step S618.

In step S620, the restoration circuit 321 performs a restoration process on the received packet (a retransmission packet).

In step S621, the combination unit 343 performs a complementing process using the initial packet and the restored retransmission packet.

All examples and conditional language provided herein are intended for pedagogical purposes to aiding the reader in understanding the invention and the concepts contributed by the inventor to further the art, and are not to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission circuit, comprising:
a buffer that stores a packet transmitted to a reception circuit;
a processing unit that reads a retransmission target packet from the buffer, when a retransmission request including processing pattern information that specifies processing to a packet is received from the reception circuit, and that performs the processing specified in the processing pattern information on the retransmission target packet; and
an output unit that outputs a processed retransmission target packet to the reception circuit.

2. The transmission circuit according to claim 1, wherein the processing unit inverts a bit in the retransmission target packet based on the processing pattern information.

3. The transmission circuit according to claim 1,
wherein the packet includes a plurality of blocks, and
wherein the processing unit performs a rearrangement of a plurality of blocks included in the retransmission target packet.

4. The transmission circuit according to claim 1,
wherein the packet includes a plurality of blocks,
wherein the retransmission request includes specification information that specifies any one of the plurality of blocks included in the retransmission target packet, and
wherein the processing unit replaces respective pieces of data of blocks other than the first block from among the plurality of blocks with data of a block specified in the specification information.

5. A reception circuit, comprising:
a buffer that stores an initial packet received first from a transmission circuit;
retransmission request means that requests that the transmission circuit retransmit a packet;
a restoration unit that restores a retransmission packet processed in the transmission circuit to a state before the processing; and
a complementing unit that combines the initial packet with a restored retransmission packet so as to configure a packet.

6. The reception circuit according to claim 5, further comprising:
an error checker that determines whether there is an error in an initial packet received from the transmission circuit, and that notifies the transmission circuit of a retransmission request including processing pattern information that specifies processing to a retransmission packet, when there is an error in the initial packet,
wherein the restoration unit restores the retransmission packet received from the transmission circuit in accordance with the processing pattern information reported to the transmission circuit.

7. A transceiver system, the transceiver system comprising a transmission circuit and a reception circuit,
wherein the transmission circuit comprises:
a first buffer that stores a packet transmitted to the reception circuit;
a processing unit that reads a retransmission target packet from the first buffer, when a retransmission request including processing pattern information that specifies processing to a packet is received from the reception circuit, and that performs the processing specified in the processing pattern information; and
an output unit that outputs a processed packet to the reception circuit, and
wherein the reception circuit comprises:
a second buffer that stores an initial packet received first from the transmission circuit;
retransmission request means that request that the transmission circuit retransmit a packet;
a restoration unit that restores a retransmission packet processed in the transmission circuit to a state before the processing; and
a complementing unit that combines the initial packet with a restored retransmission packet so as to configure a packet.

8. A method for controlling a transceiver system comprising a transmission circuit and a reception circuit, the method comprising:
transmitting, by the reception circuit, a retransmission request including processing pattern information that specifies processing of a packet to the transmission circuit;
reading, by the transmission circuit, a retransmission target packet from a buffer, when the retransmission request is received;
performing, by the transmission circuit, processing specified in the processing pattern information on the retransmission target packet;
outputting, by the transmission circuit, a processed retransmission target packet to the reception circuit;
receiving, by the reception circuit, the processed retransmission target packet;
restoring, by the reception circuit, the processed retransmission target packet to a state before the processing; and
combining, by the reception circuit, an initial packet received first from the transmission circuit with a restored retransmission target packet so as to configure a packet.
